(19) United States
(12) Patent Application Publication
(10) Pub. No.: US 2022/0203874 A1
(43) Pub. Date: Jun. 30, 2022

(54) SHOCK-ABSORBING MOUNT FOR VEHICLE SEAT

(71) Applicant: Rheinmetall Protection Systems GmbH

(72) Inventors: Francois BUDER, Bonn (DE); Michael INDEN, Kerpen (DE); Rene NEULING, Hennef (DE)

(21) Appl. No.: 17/693,595

(22) Filed: Mar. 14, 2022

Related U.S. Application Data
(63) Continuation-in-part of application No. 16/605,085, filed on Oct. 14, 2019.

(30) Foreign Application Priority Data
Apr. 13, 2017 (DE) 10 2017 108 073.2

(51) Int. Cl. B60N 2/50; B60N 2/54

(52) U.S. Cl. CPC B60N 2/502; B60N 2/506; B60N 2/544

(57) ABSTRACT

A generally vertical pillar extends between a floor and a ceiling of a vehicle chassis and carries a seat. A damper is secured between an attachment point on the pillar and an attachment point vertically offset therefrom on the vehicle chassis. This damper comprises a plurality of C-shaped springs each attached at one of the attachment points to the pillar and extending therefrom at an angle of 45° relative to the pillar and an opposite end attached at the other attachment point to the chassis and extending therefrom at an angle of 45° relative to the pillar. The springs each are elastically deformable and form force absorbers that return to a starting shape after elastic deformation. Each C-shaped spring defines a gap open at an acute angle to the vertical and that varies in dimension on deformation of the respective spring.

### CROSS REFERENCE TO RELATED APPLICATIONS

This application is a continuation-in-part of U.S. patent application Ser. No. 16/605,085 filed 14 Oct. 2019 as the US-national stage of PCT application PCT/EP2018/059603 filed 13 Apr. 2018 and claiming the priority of German patent application 102017108073.2 itself filed 13 Apr. 2017.

### FIELD OF THE INVENTION

The invention relates to a shock-absorbing damper and also to a seat for a land vehicle and that has at least one damper according to the invention.

### BACKGROUND OF THE INVENTION

Seats for land vehicles, in particular for military purposes and that have dampers in order to absorb shocks acting on the vehicle from the outside and therefore provide protection to the occupants sitting on these seats are known. Shocks acting on the vehicle from the outside are generally impacts from explosive materials, as are used for example in mines over which the vehicle drives.

DE 10 2008 053 152 discloses a deformation element for protecting a device, in particular a footrest plate in an, in particular, military vehicle, wherein the deformation element is substantially u-shaped.

### OBJECT OF THE INVENTION

The object of the invention is to provide a damper that renders possible shock absorption with reasonable expenditure on manufacture. Another object of the invention is to provide a seat for a vehicle that protects the person using it from external impacts.

### SUMMARY OF THE INVENTION

The invention proposes a damper that has at least two attachment points in order to introduce forces, which occur in a pulsed manner, into the damper.

According to the invention, the damper consists of at least one spring.

The damper further has fastening elements by which the damper can be fastened. The fastening elements are preferably arranged at the attachment points, so that the action of force on the damper can take place through the fastening elements.

The damper according to the invention further has a force absorber that is capable of absorbing introduced forces and in this way can damp the actions of force that occur in a pulsed manner.

A force absorber of this kind can be a compressible substance or an elastic substance that returns to its initial state after action of force.

To this end, the force absorber can be integrated into the springs or the force absorber constitutes the material of the springs. A plurality of springs are preferably provided for one damper.

The springs are configured such that they can absorb an action of force in order to damp forces that occur in a pulsed manner. To this end, the springs are of curved configuration. This curved shape first has the advantage that the springs are more stable than in the case of straight shapes since curved shapes can withstand greater forces than straight shapes. Second, a recess through which the springs can be deformed in the event of action of force can, however, be provided in the case of a curved shape.

The springs are initially of elastic configuration owing to the force absorber and their shaping. This means that they withstand a certain action of force without deformation. However, when this action of force becomes too great, the sides or ends of the springs can move toward one another at the recesses owing to deformation and thereby absorb and damp further forces.

Therefore, in a particular embodiment, a C-shape has proven advantageous for the springs.

The dampers are designed such that they can be used in a vehicle in order to cushion a vehicle seat against impact forces that are exerted on the seat. To this end, it is proposed to arrange at least one damper according to the invention on the seat of the vehicle.

The seat can be damped by at least one damper being arranged between the seat and the vehicle chassis. Similarly, the seat can also be arranged in a manner suspended from the ceiling of the passenger compartment. In this case, at least one damper is provided between the suspension arrangement and the ceiling.

In order to adapt the damping property to a special seat or use, the invention proposes using a plurality of springs in one damping element.

To this end, a plurality of springs can be arranged parallel to one another. They force to be absorbed by the damper is increased owing to the arrangement of a plurality of springs. An arrangement of a plurality of springs next to one another is also conceivable. The combination of a plurality of springs parallel to one another and next to one another is recommended. For example, a plurality of rows of springs on one damper could be used for this purpose.

Similarly, a plurality of springs one on the other can be used. This increases the travel of the deformation and a higher elasticity can be achieved.

The damping properties, such as elasticity and deformation travel, can be adapted to a specific purpose owing to the combination of the above-described arrangement options for the springs in one damper.

One advantage of the present invention is that the seat can be arranged in a vertically adjustable manner. The dampers according to the invention do not impede this vertical adjustment.

For vertical adjustment purposes, the seat comprises a pillar to which it is connected in an articulated manner. The seat can then be vertically adjusted on the pillar using suitable means. The dampers are then provided at the fastening of the pillar, either on the chassis of the vehicle or on the ceiling of the passenger compartment.

In both cases, the damper according to the invention is between the fastening of the seat and the chassis or the ceiling. The damper can be fitted between the seat and the chassis/ceiling by the fastening elements.

For the fastening element of the damper, the spring can also be designed as a fastening element. The seat can be arranged, in particular arranged in a vertically adjustable manner, on said fastening element where the fastening element can have a plurality of springs that can each be of C-shaped design and are connected to the chassis or the ceiling of the vehicle.

When C-shaped springs are used, the plurality of C-shaped springs can be deformed as a result of an impact on the vehicle from the outside and therefore considerably reduce the impact energy exerted on the seat, so that the person sitting on the seat is effectively protected against this external impact as a result.

If a plurality of C-shaped springs that are one behind the other are used, these are designed with one of their turning points as a fastening element on which the seat is arranged. By their other turning point, the springs are fastened to the chassis of the vehicle, or to corresponding carrier elements. With particular preference, not only are a plurality of C-shaped springs arranged one behind the other in series, but rather two or even more than two rows of springs of this kind are parallel to one another, as a result of which the shock-absorbing action of the entire damper can be adjusted.

According to the invention the damper is formed by two rows of the C-shaped springs, and the gaps of the elements of each row form a horizontally extending slot open at an acute angle, normally about 45°, to the vertical. The slot of one of the rows opens at right angle to the slot of the other of the rows.

### BRIEF DESCRIPTION OF THE DRAWING

Further features of the present invention are shown in the figures, in which:

FIG. 1 is a front view of the seat;

FIG. 2 is a side view of the seat;

FIG. 3 is a perspective view of the seat;

FIG. 4 is a top view of the seat;

FIG. 5 shows a damping element according to the invention on the pillar; and

FIGS. 6 and 7 are front and perspective views of the damping elements mounted at the pillar.

### SPECIFIC DESCRIPTION OF THE INVENTION

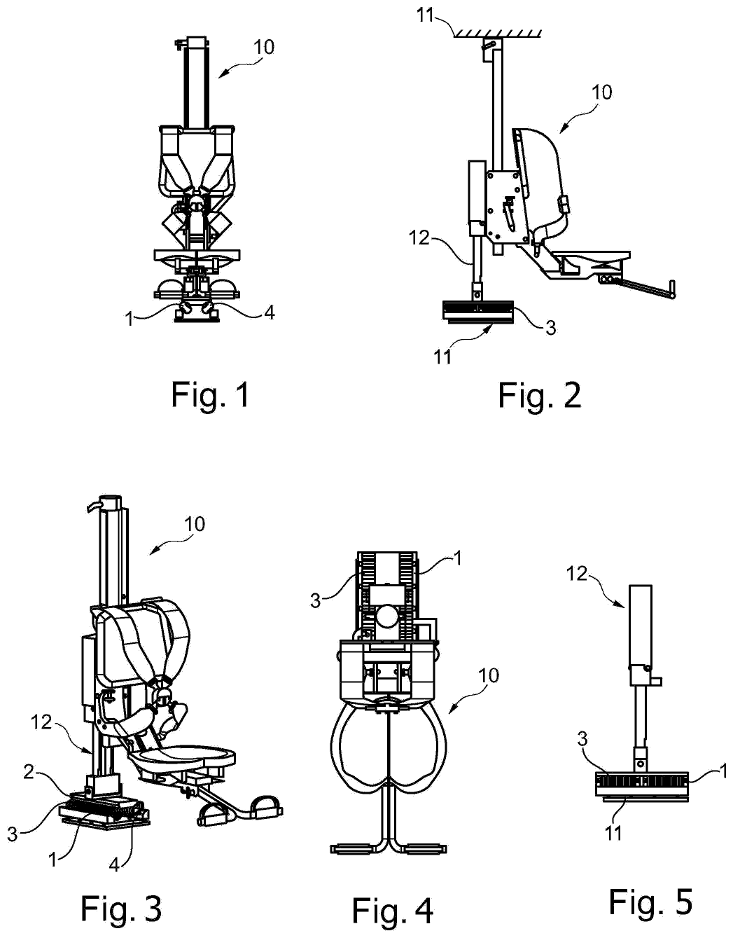

FIGS. 1 to 5 illustrate an embodiment of a damper 1 that secures a seat 10 to a floor and a ceiling of a chassis 11 of an unillustrated vehicle. The seat 10 is for example vertically adjustable on a pillar 12 that can form a constituent part of the damper 1.

At its lower end the pillar 12 is secured to the chassis floor by a plurality of springs 3 of curved shape 4, for example C-shaped, positioned at least in one row, here in two rows parallel to one another. In this case, the springs 3 together form the damper 1.

There is no, or no appreciable, deformation of the C-shaped springs 3 during normal loading of the seat 10. These C-shaped springs can deform and thereby absorb the impact energy only in the event of an impact on the vehicle from the outside. When this takes place the C-shaped springs 3 deform and in the process the free ends of the large C are able to move toward one another. In this case, the impact energy is transmitted to the damper 1 through the attachment points 2.

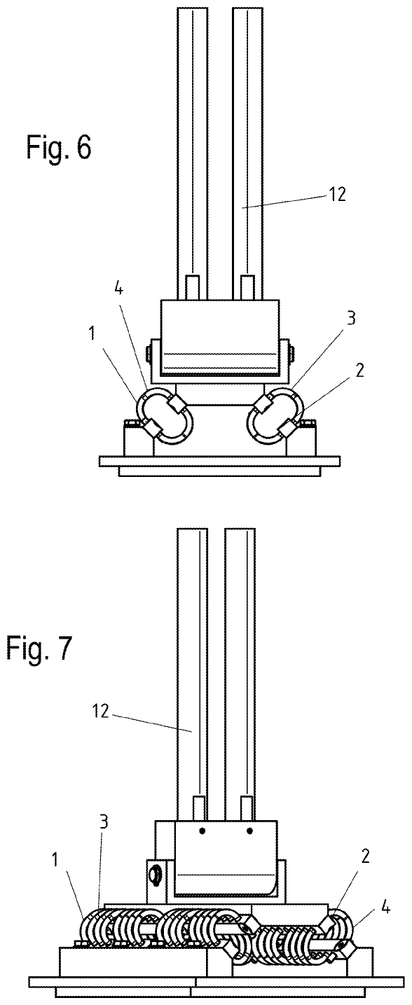

FIGS. 6 and 7 illustrate the details of the C-shaped springs 3 forming the damping element 1. On the left side, the C-shaped springs 3 are connected to the attachment points 2 in a way that a at least two C-shaped springs 3 are connected to each attachment point 2. Therefore, in FIG. 2, a C-shaped spring 3 is connected to the attachment points 2 so that the open sides of the C-shaped springs 3 are connected to the attachment points 2. This way, two C-shaped elements 2 and the attachment points 2 form a closed ring.

The attachment points 2 are situated at the lower end of the pillar 12, preferably open at an angle of 45° to the vertical pillar 12 as can be seen in FIG. 2. Also, attachment points 2 are situated at edges of a bottom element that may be used for positioning of the seat and/or the pillar 12 to the chassis floor of the vehicle. These attachment points are also preferably positioned in an angle of 45°.

The C-shaped springs 3 comprise a force-absorption means. This absorption means can be seen as the material that is used to manufacture the C-shaped springs 3. Also, the absorption means can be seen as a material inside the C-shaped springs 3. This way, the C-shaped springs 3 are elastically deformable.

On the right side of FIG. 7, the plurality of C-shaped springs 3 that form the damper 1 can be seen. Here, the C-shaped springs 3 are arrayed in rows each extending along and centered on a respective parallel axis, with the axis of the two rows parallel to each other. This, combined with the deformation of the springs 3 at 45° to the vertical improves the damping effectiveness.

When some force is exerted to the bottom the chassis 11 a grenade, this force is directed in upward parallel to the pillar 12. This force vertically compresses the damper 1 and therefore the C-shaped springs 3. Because of the elastic feature of the C-shaped springs and the deflection of the force into 45° deformation, the force is at least partly absorbed by the damper 1. The seat itself and the person that sits on the seat will produce a force that is directed in the opposite direction than the force exerted to the bottom. This force also compresses the damper 1. Therefore, compression takes place by both forces introduced into the damper 1. The elastic feature of the damper 1 dissipates the force from below will only in part be transmitted to the pillar and/or the seat.

The present invention is not restricted to the abovementioned features. Rather, further refinements are possible. Therefore, the springs can be arranged not only on the suspension arrangement or on the pillar of the seat, but rather also in the pillar itself. The vertically adjustable seat is specially damped as a result. Therefore, an individual degree of damping can be set by combining dampers in the pillar and the suspension arrangement of the seat.

The present invention is not restricted to the above-described features. Rather, further refinements are possible. Therefore, the springs can be arranged not only on the suspension arrangement or on the pillar of the seat, but rather also in the pillar itself. The vertically adjustable seat is specially damped as a result. Therefore, an individual degree of damping can be set by combining dampers in the pillar and the suspension arrangement of the seat.

We claim:

1. In combination with a vehicle chassis,
a substantially vertical pillar;
a seat carried on the pillar; and
a damper secured between an attachment point on the pillar and an attachment point vertically offset therefrom and on the vehicle chassis, the damper comprising a plurality of C-shaped springs each attached at one of the attachment points to the pillar and extending therefrom at an angle of 45° relative to the pillar and an opposite end attached at the other attachment point to the chassis and extending therefrom at an angle of 45° relative to the pillar, the springs each being elastically deformable and forming force absorbers that return to a starting shape after elastic deformation, each spring C-shaped element defining a gap open at an acute angle to the vertical and that varies in dimension on deformation of the respective spring.

2. The damper according to claim 1, wherein the force absorber is embodied as material of the springs.

3. The damper according to claim 1, wherein the force absorber consists of an elastically deformable material.

4. The damper according to claim 1, wherein the springs are in horizontal rows extending parallel to one another.

5. The damper according to claim 4, wherein the springs are next to one another in the rows.

6. A seat for a land vehicle, wherein the seat comprises at least one damper according to claim 1.

7. The seat according to claim 6, wherein the damper is between the seat and a chassis of the land vehicle.

8. The seat according to claim 6, wherein the seat is vertically adjustable on the pillar.

9. The seat according to claim 1, wherein the damper is formed by two rows of the C-shaped springs, the gaps of the elements of each row forming a horizontally extending slot open at an acute angle to the vertical.

10. The seat according to claim 9, wherein the slot of one of the rows opens at right angle to the slot of the other of the rows.
